(19) United States
(12) Patent Application Publication
(10) Pub. No.: US 2011/0207567 A1
(43) Pub. Date: Aug. 25, 2011

(54) LINEARLY ACTING TENSIONING ELEMENT

(75) Inventor: Joerg Kaiser, Lonnerstadt (DE)

(73) Assignee: SCHAEFFLER TECHNOLOGIES GMBH & CO. KG, Herzogenaurach (DE)

(21) Appl. No.: 13/128,024

(22) PCT Filed: Oct. 27, 2009
(86) PCT No.: PCT/EP2009/064109

§ 371 Date: May 6, 2011

(30) Foreign Application Priority Data
Nov. 12, 2008 (DE) 10 2008 057 041.9

(51) Int. Cl. F16H 7/08; B23P 11/00

(52) U.S. Cl. 474/110; 29/446

(57) ABSTRACT

A tensioning element of a traction drive, which has a cylindrical housing. In the housing a piston is guided in a linearly displaceable manner. In order to fasten the tensioning element (1), the housing and the piston correspondingly enclose a respective coupling point. Furthermore, a spring means, which at least in regions surrounds a guide sleeve, is arranged between the components made from plastic. The piston is guided in a linearly displaceable manner in the cylinder by a plain bearing bush. For the purpose of positional orientation and for limiting the stroke, a pin, which is inserted in the piston, engages in a longitudinal slot in the cylinder in a form-fitting manner.

### FIELD OF THE INVENTION

The invention relates to a linearly acting tensioning element which can be used in traction drives of internal combustion engines and by means of which adequate pretensioning of the traction means can be ensured. The structure of the tensioning element comprises a housing, which forms a cylinder and in which a piston is guided in a linearly displaceable manner. Moreover, a spring means is arranged between the housing and the piston in such a way that these elements are preloaded nonpositively in the installed state.

### FIELD OF THE INVENTION

Linearly acting tensioning elements are used to ensure constant pretensioning of traction means, especially endless belts in traction drives such as auxiliary unit drives and/or timing drives of internal combustion engines.

JP 53 12 240 A has disclosed a linear tensioning element comprising a tensioning roller which is in operative connection with the traction means of the traction drive. Here, the spring-loaded component of the linear tensioner is connected to a deflection roller by means of a shaft.

The construction of the linearly acting tensioning element in accordance with DE 10 2004 054 636 A1 comprises a positionally fixed, pivotably arranged base element which is connected to a sliding part fixed against rotation but capable of axial motion. Here, the sliding part is connected directly or indirectly, more particularly via a tensioning roller, to the traction means. In addition, the tensioning element includes a rotary shaft part which is arranged coaxially with respect to the sliding part and is loaded in rotation by means of a torsion spring and/or by a compression spring which is supported on a bottom element and, via a motion thread, on the sliding part. Here, the spring means simultaneously assumes the function of a mechanical damper for the traction drive.

### OBJECT OF THE INVENTION

Taking into account the known tensioning elements, it is the object of the present invention to provide an effective linear tensioning element that can be produced cost-effectively.

### SUMMARY OF THE INVENTION

This problem is solved by a device as claimed in claim 1 and by a method as claimed in claim 11.

The construction, according to the invention, of the linear tensioning element according to claim 1 comprises a housing with an integrated cylinder, in which a piston is guided by means of a plain bearing bush encased the piston over a certain area, which encases the piston over a certain area. In the installed position of the tensioning element, a spring means inserted between the piston and the housing, to which spring means a guide sleeve is assigned, brings about a nonpositive arrangement of the piston and the housing, in which they are spread apart. To provide a stroke limiter which simultaneously forms a safeguard against loss in the preassembled condition of the tensioning element, a pin, which engages positively in a longitudinal slot in the cylinder, is inserted in the piston transversely to the longitudinal axis. This pin arrangement simultaneously brings about advantageous positional orientation of the piston relative to the cylinder and the associated housing, thereby advantageously simplifying assembly.

With the linear tensioning element according to the invention, which may also be referred to as a spring means, it is possible to perform tensioning functions that correspond to a hydraulic tensioning element while allowing for smaller damping properties. If system conditions allow low damping, this tensioning element can be arranged, by means of pivot point damping for example, in a mounting of a lever interacting with the tensioning element according to the invention or directly in conjunction with the spring means, thereby obtaining a significant cost saving.

The mechanical tensioning element according to the invention thus offers a cost-effective alternative for belt drives in which the damping function of hydraulic tensioning elements is not required owing to specific system conditions. For this purpose, the tensioning element according to the invention advantageously includes screw attachment geometry corresponding to that of the hydraulic tensioning element, which allows complete interchangeability as regards installation space and adaptation of the tensioning elements.

According to the invention, plastic is provided as the material for the components comprising the housing and the piston, giving an advantageously weight-optimized construction of the linear tensioning element according to the invention.

Further advantageous embodiments of the invention form the subject matter of dependent claims 2 to 10.

A preferred embodiment of the invention envisages that the guide sleeve surrounded by the spring means forms an encircling, radially outward-directed flange at the housing end. In this arrangement, the spring means is supported on the flange via one end of the spring and, in the installed state, brings about nonpositive contact of the guide sleeve on a collar of the housing. On the one hand, this guide sleeve, which is preferably likewise made of plastic, prevents individual turns of the spring means from bulging outward and, on the other hand, brings about a desired straight-line introduction of force or transfer of the spring force into the housing. Irrespective of the operating state of the tensioning element, the guide sleeve preferably extends over almost half the length of the spring means. A helical compression spring, the first spring end of which is supported on a spring plate of the piston and a second spring end of which is supported indirectly on the collar of the housing, is advantageously used as the spring means.

For weight optimization, all the significant components, such as the piston, the housing and the guide sleeve of the tensioning element according to the invention are made of plastic. PA 66 with a glass fiber content ≧35% is preferably used as a material.

Another design measure of the invention envisages that the piston is guided in the cylinder by way of a plain bearing bush secured positively and/or nonpositively on the piston. Depending on requirements, a plain bearing bush that is closed all round or is slotted can be used. Polyamide, such as PA 66 H, can be used as a material for the plain bearing bush, the letter H defining a high thermal stability.

According to the invention, a suitable means of achieving effective stroke limitation of the piston can be obtained in a cost-effective manner by using a rolling contact needle of a commercially available needle bearing as a pin. The rolling contact needle is pressed into a transverse hole in the piston in the region of a cylindrical projection at the end.

Another measure by means of which the weight of the tensioning element according to the invention can be reduced envisages that a cross-sectional profile of the piston should be designed to he very largely cross-shaped. This cross-sectional profile extends from a spring plate of the piston to a cylindrical projection at the free end of the piston. Adjoining the cylindrical projection of the piston and pointing in the direction of the spring plate is a portion with a reduced diameter over a limited length, which is intended to accommodate the plain bearing bush.

During the assembly of the linear tensioning element according to the invention, the spring means is compressed via the guide sleeve by means of a separate tool or a separate device until the spring turns abut. This provides the possibility of pressing the pin intended for stroke limitation into the piston. A clamp of U-shaped configuration, on which a first leg is supported on the spring plate and a second leg is supported on the flange of the guide sleeve, is suitable as a tool, for example.

The invention according to claim 11 relates to a method for assembling the linear tensioning element, which comprises the following steps. First of all, a plain bearing bush is secured on the piston before the spring means is pushed axially onto the piston. A guide sleeve is then inserted in an annular gap bounded by the spring means and the piston. The cylinder, the associated housing and the piston are then assembled, the cylinder being guided on the outside of the guide sleeve. The spring means is then compressed in an end position of the piston on the housing, preferably by means of a separate tool or a separate device, until the spring turns abut and the piston is supported directly on the housing. Finally, the stroke of the piston is limited by pressing a pin into a hole in the end of the piston, said pin projecting on both sides of the piston and engaging positively in a longitudinal guide of the cylinder.

### BRIEF DESCRIPTION OF THE DRAWINGS

The invention is explained in greater detail below with reference to two drawings, which show an illustrative embodiment of the invention. In the drawings:

FIG. 1 shows a longitudinal section of a tensioning element according to the invention; and

FIG. 2 shows the tensioning element according to FIG. 1 with the spring means compressed.

### DETAILED DESCRIPTION OF THE DRAWINGS

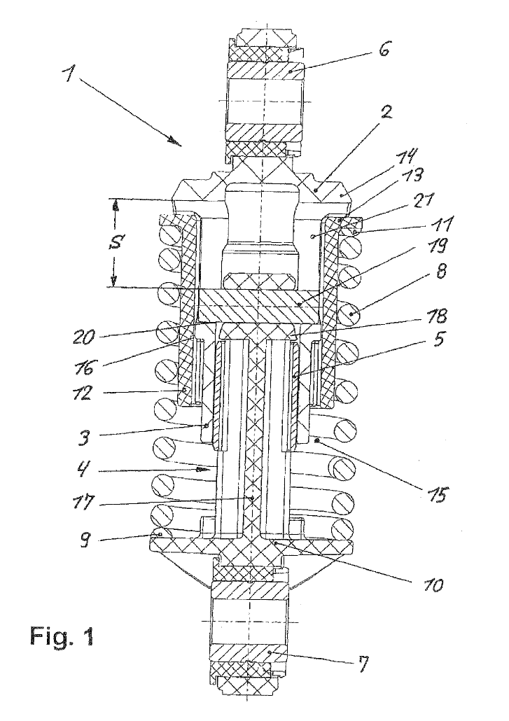

The tensioning element 1 according to FIG. 1, which is depicted in longitudinal section, comprises a housing 2, which contains a cylinder 3, which is intended to accommodate a piston 4. The piston 4 is guided by means of a plain bearing bush 5 in such a way that it can be displaced linearly in the cylinder 3. In the installed state of the tensioning element 1, the housing 2 and the piston 4 are connected to a fixed machine component and a tensioning device, for example, by way of coupling points 6, 7 designed as fastening lugs. A spring means 8 designed as a helical compression spring is inserted between the components comprising the housing 2 and the piston 4. At the piston end, the spring means 8 is supported via a first spring end 9 on a spring plate 10 connected integrally to the piston 4. The second spring end 11, which surrounds a guide sleeve 12, is supported on a flange 13 of the guide sleeve 12, the flange 13 resting nonpositively on a collar 14 of the housing 2. Over almost half the length of the spring means 8, the guide sleeve 12 fills an annular gap 15 formed between a lateral surface 16 of the cylinder 3 and an inner contour of the spring means 8. In a zone 17 formed between the spring plate 10 and a cylindrical projection 18, the piston 4 has a cross-shaped cross-sectional profile. To limit the stroke of the piston 4, a pin 19 is provided, said pin being introduced in a transverse hole 20 of the projection 18, projecting on both sides from the piston 4 and engaging positively in a longitudinal slot 21 in the cylinder 3. Here, a length of the longitudinal slot 21 defines a maximum stroke “S” of the piston 4.

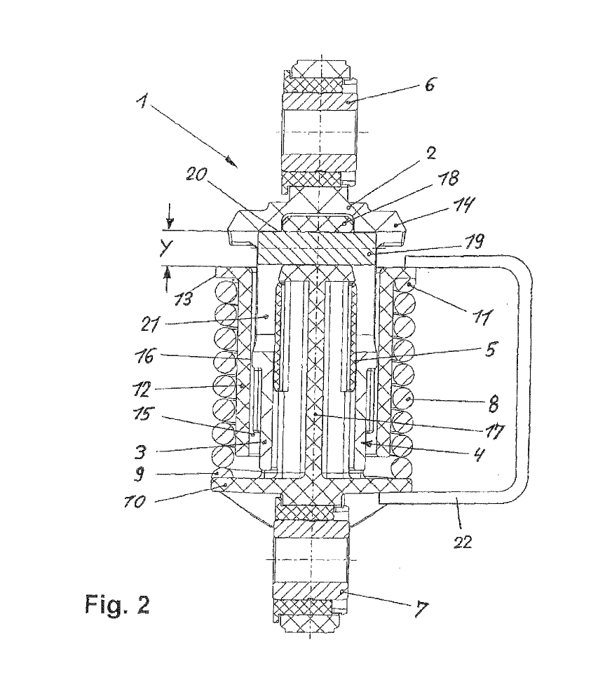

FIG. 2 shows the tensioning element 1 according to FIG. 1 in an end position, defined by support of the pin 19 on the collar 14 of the housing 2. FIG. 2 also depicts the compressed spring means 8, as a result of which a gap “y” is formed between the flange 13 of the guide sleeve 12 and the collar 14 of the housing. The compressed spring means 8 allows the pin 19 to be fitted, said pin being pressed radially into the hole 20 in the projection 18 of the piston 4 and hence forming a stroke limiter for the piston 4 and at the same time forming an effective means of safeguarding all the components of the tensioning element 1 against loss. The pin 19, which is guided on both sides of the piston 4 in the longitudinal guide 21 of the cylinder 3, furthermore brings about positional orientation between the housing 2 and the piston 4. As an assembly aid, by means of which the spring means 8 in conjunction with the guide sleeve 12 can be held in a compressed position, a holding clamp 22 is provided, said clamp being supported by one leg on the spring plate 10 and by the other leg on the flange 13 of the guide sleeve 12.

### LIST OF REFERENCE SIGNS

1 Tensioning Element
2 Housing
3 Cylinder
4 Piston
5 Plain Bearing Bush
6 Coupling Point
7 Coupling Point
8 Spring Means
9 Spring End
10 Spring Plate
11 Spring End
12 Guide Sleeve
13 Flange
14 Collar
15 Annular Gap
16 Lateral Surface
17 Zone
18 Projection
19 Pin
20 Transverse Hole
21 Longitudinal Slot
22 Holding Clamp

1-11. (canceled)

12. A linearly acting tensioning element for a traction drive of an internal combustion engine, the tensioning means, comprising:
a cylindrical housing having a longitudinal slot;
a piston, which is guided in the longitudinal slot of the housing in a linearly displaceable manner, the housing and the piston having a coinciding coupling point and the piston and the housing made from plastic;
a plain bearing bush mounted on the piston and guiding the piston in the housing;
a spring means arranged radially between the housing and the piston;
a guide sleeve positioned radially between the spring means and the housing; and
a pin mounted laterally in one end of the piston for limiting the stroke of the piston in the housing.

13. The tensioning element as claimed in claim 12, wherein the housing has a collar, and the guide sleeve has an encircling, radially outward-directed flange at a housing end, and via the flange the guide sleeve is supported non-positively on the collar of the housing in an operating state of the tensioning element.

14. The tensioning element as claimed in claim 13, wherein the guide sleeve extends over almost half a length of the spring means.

15. The tensioning element as claimed in claim 12, further comprising a spring plate mounted at the other end of the piston and a flange on the guide sleeve, wherein the spring means is a helical compression spring, which is supported at one end on the spring plate at a piston end and at another end on the flange of the guide sleeve of the housing at a housing end.

16. The tensioning element as claimed in claim 12, wherein the piston, the housing and the guide sleeve are comprised of PA 66 with a fiberglass content ≧35%.

17. The tensioning element as claimed in claim 12, wherein the plain bearing bush is closed or slotted and is secured positively and/or non-positively on the piston.

18. The tensioning element as claimed in claim 17, wherein the plain bearing bush is made of polyamide.

19. The tensioning element as claimed in claim 18, wherein the polyamide is PA 66 H.

20. The tensioning element as claimed in claim 12, wherein the pin is a rolling contact needle a needle bearing.

21. The tensioning element as claimed in claim 15, wherein the piston has a cross-shaped cross-sectional profile in a zone bounded by the spring plate and a projection of the piston.

22. The tensioning element as claimed in claim 12, wherein the spring means is compressable and/or held in a compressed position by a device or a holding clamp.

23. A method for assembling a linear tensioning clement, comprising a housing, which forms a cylinder and in which there is a plain bearing bush and a piston is guided in a linearly displaceable manner, the housing and the piston each having a coinciding coupling point, and a spring means, inside of which is positioned a guide sleeve, being arranged between the housing and the piston, the method comprising the following steps:
mounting of the plain bearing bush on the piston;
introducing the piston into the spring means;
inserting the guide sleeve into an annular gap bounded by the spring means and the piston;
assembling the cylinder, which is guided on the outside of the guide sleeve, and the piston;
compressing the spring means by a tool or a device until the spring turns abut; and
pressing a pin into a transverse hole in the piston, the pin forming a stroke limiter for the piston.
